(19) United States
(12) Patent Application Publication
(10) Pub. No.: US 2023/0365434 A1
(43) Pub. Date: Nov. 16, 2023

(54) TRANSITION METAL-DOPED CARBON MICROSPHERE, PREPARATION METHOD THEREFOR AND APPLICATION THEREOF

(71) Applicant: Guangzhou University, Guangzhou City (CN)

(72) Inventors: Weiquan CAI, Guangzhou City (CN); Pei LIU, Guangzhou City (CN)

(21) Appl. No.: 18/141,687

(22) Filed: May 1, 2023

Related U.S. Application Data
(63) Continuation of application No. PCT/CN2021/114696, filed on Aug. 26, 2021.

(30) Foreign Application Priority Data
Nov. 3, 2020 (CN) 202011214465.9

(51) Int. Cl. C02F 1/28; B01J 20/20; B01J 20/02; B01J 20/28; B01J 20/30

(52) U.S. Cl. CPC C02F 1/288; C02F 1/281; B01J 20/20; B01J 20/0222; B01J 20/0214; B01J 20/0218; B01J 20/28019; B01J 20/3078; B01J 20/3071; C02F 2101/22

(57) ABSTRACT

Disclosed are a transition metal-doped carbon microsphere, a preparation method therefor and an application thereof. The transition metal-doped carbon sphere has a uniform solid porous structure, and the transition metal is uniformly distributed inside the carbon sphere. The preparation method comprises that a carbon microsphere uniformly doped with manganese, vanadium, molybdenum and tungsten is prepared by means of a one-step hydrothermal method, is mixed with potassium oxalate, and is roasted in a protective atmosphere to obtain an activated metal-doped carbon sphere. The doped transition metal elements remain uniformly dispersed after being roasted, and do not agglomerate. The transition metal-doped carbon microsphere obtained has the following characteristics: it exhibits good adsorption properties for heavy metal ions Cr(VI), with the maximum adsorption amount being 660.7 mg/g; it can achieve advanced removal of Cr(VI) from the wastewater of which the initial Cr(VI) concentration is lower than 200 mg/L, with the residual Cr(VI) concentration after adsorption being lower than 0.05 mg/L; and it shows good application prospect in the treatment of wastewater containing heavy metal.

### TECHNICAL FIELD

The present invention belongs to the field of adsorptive separation technology, and in particular relates to a transition metal-doped carbon microsphere, a preparation method therefor and an application thereof.

### BACKGROUND

At present, the problems of water pollution have become increasingly prominent, among which the wastewater containing Cr(VI) and other heavy metal ions in metal processing and other industries has attracted attention due to its strong toxicity, easy infiltration into the soil to enter the food chain, and so on. There are many methods for treating heavy metal ion wastewater, among which the adsorption method has advantages such as simple operation, low cost, and strong practicability. However, a general adsorbent is difficult to achieve the advanced removal of heavy metal ions from wastewater. Therefore, the adsorbent with high adsorption capacity and trace removal effect has become a hot spot in the research.

An activated carbon material is a commonly used adsorbent, but it cannot completely remove trace Cr(VI). The adsorption properties of activated carbon can be greatly enhanced via its doping. At present, the reported doping schemes mainly focus on the doping with non-metallic elements such as nitrogen and phosphorus, while the reports on metal-doped carbon materials are less.

Transition metals have many characteristics because of their unique outer electronic structure. Some transition metals, which are widely distributed in the nature, non-toxic and cheap, are widely used to prepare composite carbon materials for supercapacitor electrodes, lithium-ion battery carriers, redox reaction catalysts, wave-absorbing materials, etc., and also for the adsorption and degradation of pollutants in water. Uniform doping with transition metals can not only reflect the unique electric conduction, mass transfer, stability and other excellent physicochemical properties of carbon materials, but also realize the application of carbon materials in catalysis, adsorption, electrochemistry and other fields by adjusting the doping amounts of metal elements, making the carbon materials have broad application prospect. In particular, the transition metals and carbon materials form spherical composite materials, which will greatly increase the mechanical stability of the composite materials.

The present invention focuses on doping carbon spheres with transition metals such as manganese (Mn), vanadium (V), molybdenum (Mo), and tungsten (W). Taking Mn as an example, it can be compounded with carbon spheres in various ways, either through a hydrothermal reaction of a carbon source with a manganese salt, or through deposition of a manganese salt on the surface of the existing carbon material by the pore volume immersion method and then roasting.

In the reports on the hydrothermal preparation of manganese carbon (Mn—C) composite materials, the manganese salt is used as the main raw material, with the obtained product being a material mainly composed of manganese oxides, while the carbon source is generally used in the form of carbon spheres as a template for the growth of manganese oxides, thereby obtaining core-shell C—Mn composite materials. For example, Yu Jiaguo et al. (Chinese invention CN110335758A) added hollow carbon spheres to an aqueous solution of potassium permanganate (KMnO₄) and cobalt salts to make cobalt manganate grow on the surface of carbon spheres, forming Mn—C composite microspheres that could be used as supercapacitors. The carbon particles, as the core, were coated outside with granular, flaky or rod-shaped manganese oxides. The manganese oxide particles of this composite material were loosely bound, and hollow manganese oxide microspheres could be obtained after removal of the carbon cores by roasting. However, the manganese oxide shell was weak in mechanical strength and easy to break after losing the support of carbon core, and such Mn—C composite materials could not reflect the unique chemical inertia, expansion stability, electric conductivity, variable textural property and other characteristics of carbon materials.

With the pore volume immersion method, a carbon precursor needs to be prepared in advance, then manganese ions are doped into the precursor through infiltration and adsorption, and then roast is carried out at high temperature, so as to convert the manganese ions into manganese oxides. For example, Jiang Zhi et al. (Chinese invention CN107876044A) made manganese ions of various valence states adsorbed in porous carbon spheres, and then conducted heat treatment, thereby obtaining the carbon spheres doped with manganese oxides. Yi Qingfeng et al. (CN108899217A) loaded Mn²⁺ on the inner wall of the hollow carbon spheres, and then oxidized the Mn²⁺ with KMnO₄ into MnO₂, thereby doping MnO₂ in the carbon spheres; or the hollow carbon spheres were directly added to a KMnO₄ solution, so that MnO₄ loaded on the carbon spheres could be converted into the MnO₂ dopant due to the reducibility of carbon at high temperature (Chinese invention CN109727783A). There are also some similar reports (J. Mater. Chem. A, 2014, 2, 2555-2562; ACS Appl. Mater. Inter., 2014, 6, 9689-9697; Electrochim. Acta, 2016, 191, 1018-1025). The manganese oxides in the Mn—C composite material prepared by the immersion method have a small crystal size, uniform dispersion, and a high utilization rate of manganese element. However, the manganese oxides may block the pores of activated carbon, resulting in a reduction in the specific surface area and pore volume of carbon composite materials; moreover, due to the limited adsorption amount of the carbon precursor for Mn, the doping amount of Mn in the prepared composite materials is very small, usually less than 0.1%, and it is difficult to get improved.

Jiang Xiang et al. (Chinese invention CN108682871A) prepared MnO₂-doped carbon spheres by dropping a potassium permanganate solution into a boiling glucose solution. However, this method could not control the morphology of the obtained carbon materials, most of which were amorphous carbon slag with low mechanical strength.

There are also similar reports on doping with other transition metals, such as vanadium, molybdenum, and tungsten. For example, preformed patterned carbon spheres were loaded with molybdate, and then roasted in a nitrogen atmosphere, thereby obtaining molybdenum-doped carbon spheres (Chinese invention CN110787823A); polydopamine microspheres were coated with molybdenum disulfide, and then carbonized, thereby forming a molybdenum dopant coating (Chinese inventions CN106981647A and CN108231426A); tungsten salt, carbon black and activated carbon were roasted at high temperature in a hydrogen atmosphere to realize doping (Chinese invention CN110885114A). However, these methods are somewhat cumbersome.

### SUMMARY

In order to overcome the shortcomings and deficiencies of the prior art, the primary object of the present invention is to provide a one-step method to prepare transition metal-doped carbon microspheres (referred to as transition metal-doped carbon spheres for short), and to prepare, through activation, porous carbon spheres with good adsorption properties for the heavy metal pollutant Cr(VI).

The method of the present invention makes use of the hydrothermal carbonization of transition metal salts and sucrose with the aid of persulfate to prepare carbon spheres (CS) uniformly doped with transition metals in a short time, and then mixes the carbon spheres with potassium oxalate for high-temperature roasting, thereby obtaining porous activated carbon spheres (ACS) doped with transition metals.

A second object of the present invention is to provide a transition metal-doped carbon microsphere prepared by the above method.

A third object of the present invention is to provide an application of the above transition metal-doped carbon microspheres. The ACS prepared by the present invention has the transition metal atoms well dispersed therein and has rich micropores, such that it has good adsorption properties for Cr(VI) in wastewater.

The objects of the present invention are achieved through the following solution:

A method for preparing transition metal-doped carbon spheres is provided, comprising the following steps: mixing sucrose, transition metal salts and persulfate in water, then transferring the obtained mixed liquid into a hydrothermal kettle, and then carrying out a hydrothermal reaction at 180° C. for 4 h; cooling, washing, separating, and then drying the reaction products to obtain carbon microspheres; then mixing the carbon microspheres with potassium oxalate, and heating the mixture to a temperature of 600° C. to 800° C. to roast in a protective atmosphere for 1-3 h, thereby obtaining the carbon spheres doped with transition metals (i.e. the transition metal-doped carbon microspheres).

The transition metals in the present invention include manganese, vanadium, molybdenum and tungsten, which are uniformly distributed inside the carbon microspheres.

The transition metal salts include at least one of potassium permanganate, sodium orthovanadate, sodium molybdate dihydrate, and sodium tungstate dihydrate.

The persulfate is preferably ammonium persulfate.

The addition amount of sucrose is 4 parts by mass, the addition amount of transition metal salts is 1-4 parts by mass, and the addition amount of persulfate is 1-5 parts by mass.

The washing refers to repeated washing with water and ethanol.

The addition amount of carbon microspheres is 1 part by mass, and the addition amount of potassium oxalate is 1-4 parts by mass.

In the roasting, the temperature is raised to a range of 600° C. to 800° C. at a heating rate of 1° C./min to 5° C./min, preferably 3° C./min.

The roasting is preferably carried out at 700° C. for 2 h.

The roasting is carried out in a protective atmosphere of nitrogen or inert gas.

The prepared transition metal-doped carbon spheres have a uniform solid porous structure, and the transition metals are uniformly distributed inside the carbon spheres, such that the carbon spheres can be used to adsorb Cr(VI) in wastewater.

The transition metal-doped carbon spheres are used for adsorption of Cr(VI) in wastewater, with the maximum adsorption amount thereof being 160.4-660.7 mg/g; when the concentration of Cr(VI) ions in wastewater is less than 200 mg/L, the advanced removal of Cr(VI) can be achieved, so that the concentration of Cr(VI) in wastewater is lower than that provided by the national drinking water standard (GB 5749-2006).

In the method of the present invention, the hydrothermal method in step (1) can realize the one-step preparation of carbon spheres uniformly doped with transition metals, and the content of transition metals in the carbon spheres can reach a range of 0.9% to 10.6%. The method of the present invention is different from the multi-step method of the prior art, in which the matrix carbon material or precursor needs to be pre-prepared, then the doping of transition metals is realized through loading, and then carbonization is carried out. In the method of the present invention, the transition metals are uniformly distributed, and are high and adjustable in content; and the reaction takes only 4 h to complete, which greatly shortens the reaction time and reduces the energy consumption.

In the method of the present invention, the transition metal-doped hydrothermal carbon spheres are roasted with potassium oxalate, so as to get activated at high temperature using potassium oxalate, thereby obtaining activated carbon spheres ACS with enhanced porosity, which effectively keeps the morphology of the carbon spheres unchanged and keeps the transition metals uniformly distributed and not agglomerated; with the specific surface area and pore structure increasing significantly, the specific surface area reaches 1406 m²/g, which is obviously higher than that of the activated carbon spheres undoped with transition metals (784 m²/g).

In the method of the present invention, the activated transition metal-doped carbon spheres can be used for the treatment of Cr(VI)-containing wastewater, exhibiting good adsorption properties. In an aqueous solution with pH 1-2, the maximum adsorption amount of Mn-doped ACS for Cr(VI) could reach 660.7 mg/g; in a solution with the Cr(VI) concentration less than 200 mg/L, the adsorptive removal rate of Mn-doped ACS for Cr(VI) could reach 97.5% or more within 40 min, and the advanced removal of Cr(VI) could be achieved, enabling the solution to reach the national drinking water standard in terms of the Cr(VI) concentration; the removal rate for Cr element could reach 95.5%, and the dissolution rate of Mn in this process was so low that the dissolution of Mn could be ignored (the element content was detected by ICP).

Compared with the prior art, the present invention has the following advantages and beneficial effects:

Compared with the prior art, the present invention proposes for the first time to carry out a hydrothermal reaction altogether with transition metal salts (KMnO₄, Na₃VO₄, Na₂MoO₄·2H₂O, and Na₂WO₄·2H₂O), persulfate and sucrose to obtain transition metal-doped carbon spheres. During the hydrothermal reaction, transition metal salts are reduced by glucose to their corresponding metal ions or oxides, and meanwhile persulfate accelerates the formation of carbon spheres and made rich carboxyl groups formed on the surfaces thereof. Persulfate also provides an acidic environment during decomposition, so that the carbon spheres do not cross-link during growth. The carboxyl groups on the surfaces of carbon spheres capture metal ions or the oxides thereof, so that during the continuous growth of carbon spheres, metal atoms are wrapped inside the carbon spheres layer by layer to form a uniformly doped structure. In addition, the particles of metals (or their oxides) in the carbon spheres are separated by a carbon layer and difficult to fuse together. The distribution of the metal atoms in the doped carbon spheres is similar to that of single atoms.

In a protective atmosphere of nitrogen or inert gas, after the high-temperature activation with potassium oxalate, CO or CO₂ formed by the combination of carbon and oxygen inside the carbon microspheres escapes from the carbon microspheres, forming rich micropores and significantly increasing the specific surface area of the carbon microspheres. Meanwhile, due to the isolation of the carbon layer, the metal particles will not form a large volume of aggregation, but will still be uniformly distributed inside the carbon spheres, making the carbon spheres exhibit excellent reduction and adsorption properties for Cr(VI). Taking Mn-doped activated carbon spheres as an example, their maximum adsorption amount could reach 660.7 mg/g, and the content of Mn element in the solution after adsorption was only 0.009 mg/L measured by ICP, indicating almost no dissolution. The adsorption capacities of V-doped, Mo-doped, and W-doped activated carbon spheres for Cr(VI) prepared by this method are all greatly improved.

### BRIEF DESCRIPTION OF THE DRAWINGS

FIG. 1 shows SEM photos of the Mn-doped carbon sphere (Mn-CS) and control sample (Mn—C) prepared in Example 1.

FIG. 2 shows SEM photos of Mn-ACS obtained from Mn-CS in Example 2 after the high-temperature activation with potassium oxalate.

FIG. 3 is an element distribution diagram of Mn-CS and Mn-ACS in Example 2, in which A: Mn-CS; B: sections of broken Mn-CS; C: Mn-ACS; and D: sections of broken Mn-ACS.

FIG. 4 shows the adsorption amount of Mn-ACS in Example 2 on solutions with different initial Cr(VI) concentrations, and the residual Cr(VI) concentrations.

FIG. 5 shows SEM photos of the V-doped carbon sphere (V-CS) and control sample (V-C) prepared in Example 3.

FIG. 6 shows SEM photos of the Mo-doped carbon sphere (Mo-CS) and control sample (Mo-C) prepared in Example 4.

FIG. 7 shows SEM photos of the W-doped carbon sphere (W-CS) and control sample (W-C) prepared in Example 5.

### DETAILED DESCRIPTION OF THE EMBODIMENTS

The present invention will be further described below in detail with reference to examples and drawings, but the embodiments of the present invention are not limited thereto. Process parameters not specified can be determined with reference to conventional technology.

The materials involved in the following examples are commercially available. The dosage of each component is calculated in parts by mass and volume (g/mL).

### Example 1

This example relates to the preparation of Mn-doped carbon spheres (Mn-CS), the preparation of Mn-doped carbon materials (Mn—C) as a control sample, and the preparation of Mn-ACS through the non-destructive activation of Mn-CS with potassium oxalate.

The preparation of Mn-CS was as follows: Dissolving 4 parts by mass of sucrose, 1 part by mass of KMnO₄, and 3 parts by mass of APS (ammonium persulfate) in 40 parts by volume of water, then transferring the obtained mixed liquid into a stainless-steel hydrothermal kettle lined with polytetrafluoroethylene and placing the kettle in a hot air oven, and then heating up to 180° C. and reacting at this temperature for 4 h; filtering the obtained reaction solution to obtain a filter cake, then washing the filter cake respectively with water and ethanol for three times, and finally drying the filter cake in a hot air oven at 80° C. for 8 h, thereby obtaining Mn-CS with a manganese content of 0.89 wt %.

The control sample Mn—C was prepared by the same method as above without the addition of APS. A control sample CS was prepared by the same method as above without the addition of KMnO₄ and APS.

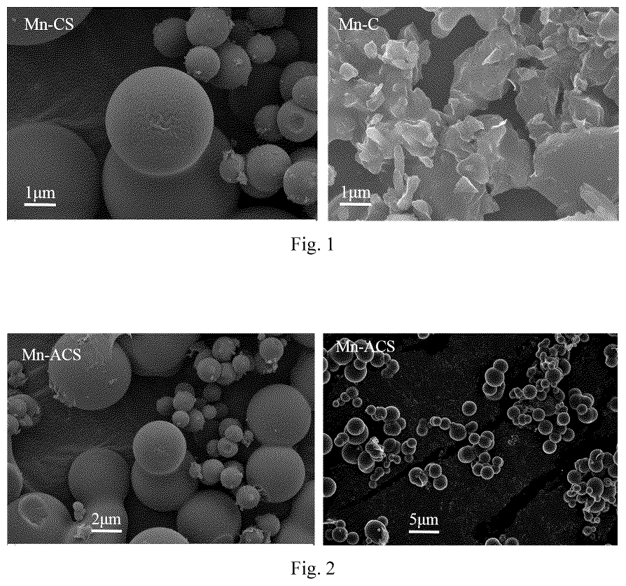

FIG. 1 shows SEM photos of Mn-CS and Mn—C for comparison, in which Mn-CS appeared as smooth spheres and Mn—C as fused flakes.

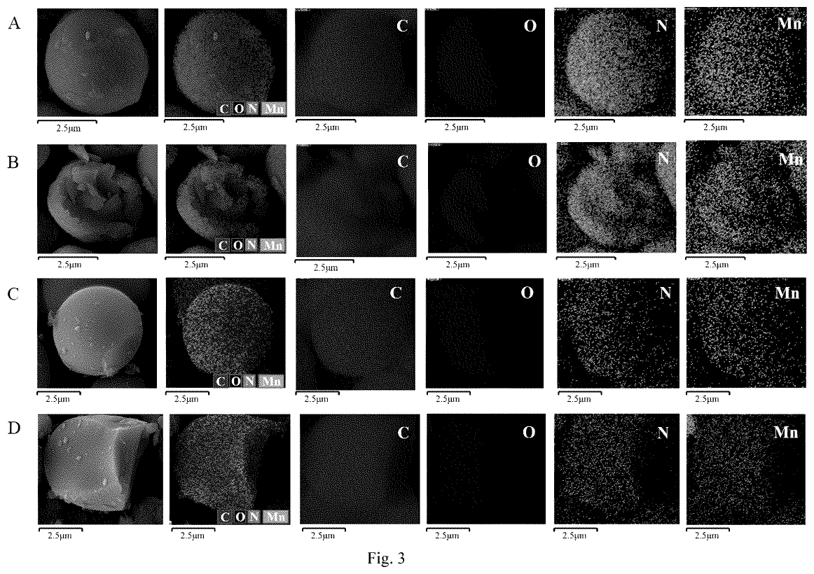

The preparation of Mn-ACS was as follows: Taking 1 part by mass of the Mn-CS sample, mixing it with 3 parts by mass of potassium oxalate uniformly, transferring the obtained mixture into a ceramic boat, placing the boat in a tubular furnace, introducing nitrogen to replace the air in the furnace, then adjusting the nitrogen flow to 30 mL/min, raising the temperature to 600° C. at a heating rate of 3° C./min to roast for 2 h, and then naturally cooling to room temperature; then washing the black powder obtained from the roasting with water until a neutral filter cake was obtained, and finally drying the filter cake in a hot air oven at 110° C. for 6 h, thereby obtaining the Mn-doped activated carbon spheres Mn-ACS. By the same method, CS was activated to prepare a control sample ACS. The SEM photos of Mn-ACS are shown in FIG. 2, indicating that Mn-ACS maintained smooth and spherical after the activation.

100 mg of Mn-ACS and 100 mg of ACS were respectively added into two beakers respectively containing 100 mL of a Cr(VI) solution (800 mg/L, pH=1-2), and then the beakers were shaken in a rotary shaker at 25° C. at a rotational speed of 180 rpm for 5 h for an adsorption experiment. The adsorption amount of Mn-ACS for Cr(VI) was 272.8 mg/g, while the adsorption amount of undoped activated carbon spheres ACS for Cr(VI) was only 96.2 mg/g.

### Example 2

This example relates to the preparation of Mn-doped carbon spheres (Mn-CS), and the preparation of Mn-ACS through the non-destructive activation of Mn-CS with potassium oxalate.

The preparation of Mn-CS was as follows: Dissolving 4 parts by mass of sucrose, 4 part by mass of KMnO₄, and 5 parts by mass of APS in 40 parts by volume of water, then transferring the obtained mixed liquid into a stainless-steel hydrothermal kettle lined with polytetrafluoroethylene and placing the kettle in a hot air oven, and then heating up to 180° C. and reacting at this temperature for 4 h; filtering the obtained reaction solution to obtain a filter cake, then washing the filter cake respectively with water and ethanol for three times, and finally drying the filter cake in a hot air oven at 80° C. for 8 h, thereby obtaining Mn-CS with a manganese content of 2.31 wt %.

The preparation of Mn-ACS was as follows: Taking 1 part by mass of the Mn-CS sample, mixing it with 3 parts by mass of potassium oxalate uniformly, transferring the obtained mixture into a ceramic boat, placing the boat in a tubular furnace, introducing nitrogen to replace the air in the furnace, then adjusting the nitrogen flow to 30 mL/min, raising the temperature to 800° C. at a heating rate of 3° C./min to roast for 2 h, and then naturally cooling to room temperature; then washing the black powder obtained from the roasting with water until a neutral filtrate was obtained, and finally drying the obtained filter cake in a hot air oven at 110° C. for 6 h, thereby obtaining the Mn-doped activated carbon spheres Mn-ACS.

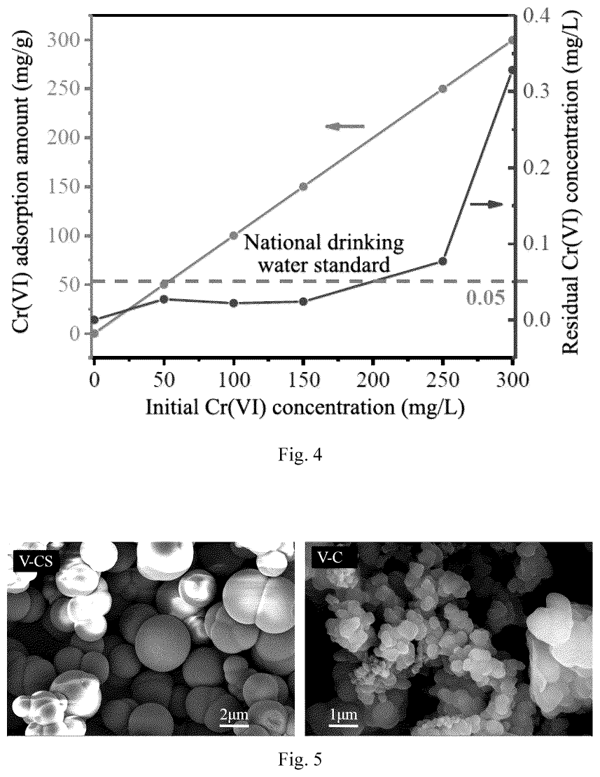

The corresponding element distribution diagrams of Mn-CS and Mn-ACS are shown in FIGS. 3 and 4, which indicate that the Mn atoms were uniformly distributed in the carbon spheres, and the roasting did not cause non-obvious aggregation of the Mn atoms.

By the same method as in Example 1, the obtained Mn-ACS was tested for Cr(VI) adsorption, showing that the maximum adsorption amount of Mn-ACS for Cr(VI) was 660.7 mg/g. 100 mg of Mn-ACS was respectively added into six beakers respectively containing 100 mL of a Cr(VI) solution (respectively at a concentration of 0, 50, 100, 150, 250 and 300 mg/L, pH=2), and then the beakers were shaken in a rotary shaker at 25° C. at a rotational speed of 180 rpm for 5 h for an adsorption experiment. The measured adsorption amount and the concentration of residual Cr(VI) in the solution are shown in FIG. 5; in the solution with the initial Cr(VI) concentration lower than 200 mg/L, the residual Cr(VI) concentration of the solution after adsorption was lower than 0.05 mg/L (the allowable Cr(VI) concentration in drinking water according to GB 5749-2006).

### Example 3

This example relates to the preparation of V-doped carbon spheres (V-CS), the preparation of V-doped carbon materials (V-C) as a control sample, and the preparation of V-ACS through the non-destructive activation of V-CS with potassium oxalate.

The preparation of V-CS was as follows: Dissolving 4 parts by mass of sucrose, 1 part by mass of Na₃VO₄, and 3 parts by mass of APS in 40 parts by volume of water, then transferring the obtained mixed solution into a stainless-steel hydrothermal kettle lined with polytetrafluoroethylene and placing the kettle in a hot air oven, and then heating up to 180° C. and reacting at this temperature for 4 h; filtering the obtained reaction solution to obtain a filter cake, then washing the filter cake respectively with water and ethanol for three times, and finally drying the filter cake in a hot air oven at 80° C. for 8 h, thereby obtaining V-CS with a vanadium content of 2.59 wt %.

The control sample V-C was prepared by the same method as above without the addition of APS. FIG. 5 shows SEM photos of V-CS and V-C for comparison, in which V-CS appeared as smooth spheres and V-C as fused irregular blocks.

The preparation of V-ACS was as follows: Taking 1 part by mass of the V-CS sample, mixing it with 3 parts by mass of potassium oxalate uniformly, transferring the obtained mixture into a ceramic boat, placing the boat in a tubular furnace, introducing nitrogen to replace the air in the furnace, then adjusting the nitrogen flow to 30 mL/min, raising the temperature to 700° C. at a heating rate of 3° C./min to roast for 2 h, and then naturally cooling to room temperature; then washing the black powder obtained from the roasting with water until a neutral filter cake was obtained, and finally drying the filter cake in a hot air oven at 110° C. for 6 h, thereby obtaining the V-doped activated carbon spheres V-ACS.

100 mg of V-ACS was added into a beaker containing 100 mL of a Cr(VI) solution (500 mg/L, pH=1-2), and then the beaker was shaken in a rotary shaker at 25° C. at a rotational speed of 180 rpm for 5 h for an adsorption experiment. The adsorption amount of V-ACS for Cr(VI) was 193.4 mg/g.

### Example 4

This example relates to the preparation of Mo-doped carbon spheres (Mo-CS), the preparation of Mo-doped carbon materials (Mo-C) as a control sample, and the preparation of Mo-ACS through the non-destructive activation of Mo-CS with potassium oxalate.

The preparation of Mo-CS was as follows: Dissolving 4 parts by mass of sucrose, 1 part by mass of Na₂MoO₄·2H₂O, and 3 parts by mass of APS in 40 parts by volume of water, then transferring the obtained mixed liquid into a stainless-steel hydrothermal kettle lined with polytetrafluoroethylene and placing the kettle in a hot air oven, and then heating up to 180° C. and reacting at this temperature for 4 h; filtering the obtained reaction solution to obtain a filter cake, then washing the filter cake respectively with water and ethanol for three times, and finally drying the filter cake in a hot air oven at 80° C. for 8 h, thereby obtaining Mo-CS with a molybdenum content of 10.62 wt %.

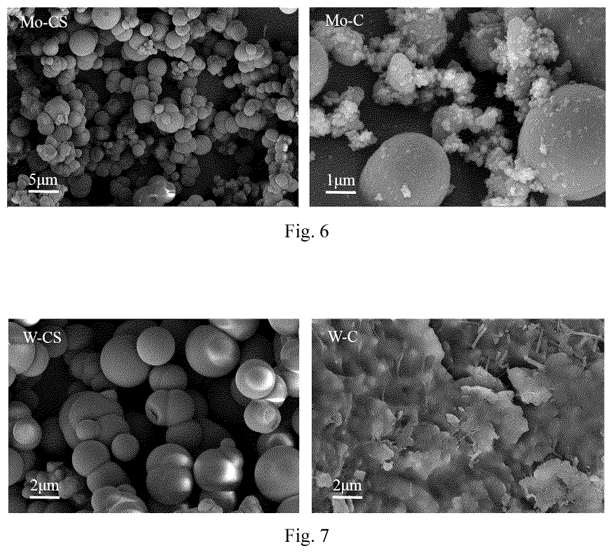

The control sample Mo-C was prepared by the same method as above without the addition of APS. FIG. 6 shows SEM photos of Mo-CS and Mo-C for comparison, in which Mo-CS appeared as smooth spheres and Mo-C as fused irregular slag, some molybdenum oxide particles being wrapped on the spheres, the remaining molybdenum oxides being mixed in the carbon materials in the form of chips.

The preparation of Mo-ACS was as follows: Taking 1 part by mass of the Mo-CS sample, mixing it with 3 parts by mass of potassium oxalate uniformly, transferring the obtained mixture into a ceramic boat, placing the boat in a tubular furnace, introducing nitrogen to replace the air in the furnace, then adjusting the nitrogen flow to 30 mL/min, raising the temperature to 800° C. at a heating rate of 3° C./min to roast for 2 h, and then naturally cooling to room temperature; then washing the black powder obtained from the roasting with water until a neutral filtrate was obtained, and finally drying the obtained filter cake in a hot air oven at 110° C. for 6 h, thereby obtaining the Mo-doped activated carbon spheres Mo-ACS.

According to the method in Example 3, the adsorption amount of Mo-ACS for Cr(VI) was 191.7 mg/g.

### Example 5

This example relates to the preparation of W-doped carbon spheres (W-CS), the preparation of W-doped carbon materials (W-C) as a control sample, and the preparation of W-ACS through the non-destructive activation of W-CS with potassium oxalate.

The preparation of W-CS was as follows: Dissolving 4 parts by mass of sucrose, 1 part by mass of Na₂WO₄·2H₂O, and 3 parts by mass of APS in 40 parts by volume of water, then transferring the obtained mixed liquid into a stainless-steel hydrothermal kettle lined with polytetrafluoroethylene and placing the kettle in a hot air oven, and then heating up to 180° C. and reacting at this temperature for 4 h; filtering the obtained reaction solution to obtain a filter cake, then washing the filter cake respectively with water and ethanol for three times, and finally drying the filter cake in a hot air oven at 80° C. for 8 h, thereby obtaining W-CS with a tungsten content of 3.31 wt %.

The control sample W-C was prepared by the same method as above without the addition of APS. FIG. 7 shows SEM photos of W-CS and W-C for comparison, in which W-CS appeared as smooth spheres, and W-C appeared as fused blocks where tungsten oxides of large particles (granular and rod-shaped) could be seen.

The preparation of W-ACS was as follows: Taking 1 part by mass of the W-CS sample, mixing it with 3 parts by mass of potassium oxalate uniformly, transferring the obtained mixture into a ceramic boat, placing the boat in a tubular furnace, introducing nitrogen to replace the air in the furnace, then adjusting the nitrogen flow to 30 mL/min, raising the temperature to 800° C. at a heating rate of 3° C./min to roast for 2 h, and then naturally cooling to room temperature; then washing the black powder obtained from the roasting with water until a neutral filtrate was obtained, and finally drying the obtained filter cake in a hot air oven at 110° C. for 6 h, thereby obtaining the W-doped activated carbon spheres W-ACS.

According to the method in Example 3, the adsorption amount of W-ACS for Cr(VI) was 160.4 mg/g.

In the above examples, the concentration of the heavy metal ion Cr(VI) was detected by the diphenylcarbazide spectrophotometry, and the UVmini-1240 UV-VIS spectrophotometer used was from Shimadzu, Japan; the content of transition metal dopants was determined by the inductively coupled plasma-atomic emission spectrometry, and the Prodigy7 full-spectrum direct-reading plasma emission spectrometer used was from Leeman Labs Inc., USA; and the surface microstructure of samples was detected by JSM-IT300 scanning electron microscope produced by Japan Electronics Co., Ltd.

The above examples are preferred embodiments of the present invention, but the embodiments of the present invention are not limited thereto, and any other alterations, modifications, replacements, combinations and simplifications made without departing from the spirit and principle of the present invention shall all be equivalent substitutions and included in the scope of protection of the present invention.

What is claimed is:

1. A method for preparing transition metal-doped carbon spheres, characterized in that the method comprises the following steps: mixing sucrose, transition metal salts and persulfate in water, then transferring the obtained mixed liquid into a hydrothermal kettle, and then carrying out a hydrothermal reaction at 180° C. for 4 h; cooling, washing, separating, and then drying the reaction products to obtain carbon microspheres; then mixing the carbon microspheres with potassium oxalate, and heating the mixture to a temperature of 600° C. to 800° C. to roast in a protective atmosphere for 1-3 h, thereby obtaining the carbon spheres doped with transition metals.

2. The method for preparing transition metal-doped carbon spheres according to claim 1, characterized in that: the transition metal salts include at least one of potassium permanganate, sodium orthovanadate, sodium molybdate dihydrate, and sodium tungstate dihydrate; and the persulfate is ammonium persulfate.

3. The method for preparing transition metal-doped carbon spheres according to claim 1, characterized in that: the addition amount of sucrose is 4 parts by mass, the addition amount of transition metal salts is 1-4 parts by mass, and the addition amount of persulfate is 1-5 parts by mass.

4. The method for preparing transition metal-doped carbon spheres according to claim 1, characterized in that: the addition amount of carbon microspheres is 1 part by mass, and the addition amount of potassium oxalate is 1-4 parts by mass.

5. The method for preparing transition metal-doped carbon spheres according to claim 1, characterized in that: in the roasting, the temperature is raised to a range of 600° C. to 800° C. at a heating rate of 1° C./min to 5° C./min.

6. The method for preparing transition metal-doped carbon spheres according to claim 1, characterized in that: the roasting is carried out at 700° C. for 2 h.

7. The method for preparing transition metal-doped carbon spheres according to claim 1, characterized in that: the roasting is carried out in a protective atmosphere of nitrogen or inert gas.

8. A transition metal-doped carbon sphere prepared by the method according to claim 1.

9. An application of the metal-doped carbon sphere according to claim 8 in adsorption of Cr(VI) in wastewater.
